(19) United States
(12) Patent Application Publication
(10) Pub. No.: US 2016/0049982 A1
(43) Pub. Date: Feb. 18, 2016

(54) MULTIFUNCTION BACK COVER FOR CELL PHONE

(71) Applicant: Taiwan Anjie Electronics Co., Ltd., Hsinchu City (TW)

(72) Inventor: Yu-Ming CHANG, Hsinchu City (TW)

(21) Appl. No.: 14/826,964

(22) Filed: Aug. 14, 2015

(30) Foreign Application Priority Data
Aug. 15, 2014 (TW) 103214577

(51) Int. Cl. H04B 1/3888; H04W 76/00; H04W 4/02; H04W 4/22

(52) U.S. Cl. CPC H04B 1/3888; H04W 4/22; H04W 76/007; H04W 4/02

(57) ABSTRACT

A multifunction back cover for cell phone is disclosed. The back cover is installed on a cell phone body having at least one application mode. An entity button and an electric quantity indicator are disposed on the back cover. A main controller built in the back cover cooperates with a function operation mode of the entity button and the application mode of the cell phone body. When a user presses down the entity button to switch the function operation mode, the main controller sends out a control signal. A battery is built in the back cover to provide enough power to the entity button. An electricity controller can monitor the electric quantity of the battery to control the electric quantity indicator to show the electric quantity signal.

### BACKGROUND OF THE INVENTION

This application claims priority for Taiwan patent application no. 103214577 filed on Aug. 15, 2014, the content of which is incorporated by reference in its entirely.

### FIELD OF THE INVENTION

The present invention relates to a back cover for cell phone, particularly to a multifunction back cover for cell phone, wherein the back cover has a spare power and a button used to switch a function in cooperation with the application mode of the cell phone.

### DESCRIPTION OF THE RELATED ART

Mobile phones have become smart phones with compact volumes and multifunction with technological advancements. The smart phones are indispensable communication products for people. However, in order to obtain consumers' favor, the cell phone industry endlessly changes application programs and shapes of cell phones instead of designing bodies of the cell phones in application. Thus, an opportunity for leading consumers and changing the bodies of the cell phones cannot be created.

Take an existing back cover of a cell phone for example. It is provided with a hole connected with a camera and a speaker hole. Alternatively, the back cover has a shape with various profiles or patterned designs. The back cover does not have any functional design. As a result, the back cover is only used as a protection cover to protect the body of the cell phone. All the functions are performed by the body of the cell phone. When the power of the cell phone body is used up, a user cannot appeal for help by the cell phone even in an emergency case. In other words, the practicability of the cell phone is limited. Accordingly, how to improve additional values and convenience of the cell phones is a problem to be solved.

To overcome the abovementioned problems, the present invention provides a multifunction back cover for cell phone, so as to solve the afore-mentioned problems of the prior art.

### SUMMARY OF THE INVENTION

A primary objective of the present invention is to provide a multifunction back cover for cell phone, which cooperates with the mainframe of the cell phone without changing the shape and structure of the cell phone, and which connects a built-in battery and an entity button with the cell phone body, and which performs functional application in cooperation with the application mode of the cell phone body to improve industrial application value and convenience of use.

To achieve the abovementioned objectives, the present invention provides a multifunction back cover for cell phone, which is installed on a cell phone body, and the cell phone body has at least one application mode. The multifunction back cover comprises a back cover body, an entity button, a battery, an electric quantity indicator, a main controller and an electricity controller. The entity button and the electric quantity indicator are disposed on the cell phone body. The battery, the main controller and the electricity controller are disposed in the cell phone body. The entity button provides at least one function operation mode. The battery is coupled to the entity button and provides enough operation power of the entity button. The electric quantity indicator shows an electric quantity signal according to electric quantity of the battery. The main controller is coupled to the entity button, cooperates with the function operation mode of the entity button and the application mode of the cell phone body and sends out a control signal according to the function operation mode. The electricity controller is coupled to the battery, the electric quantity indicator and the entity button. The electricity controller monitors the electric quantity of the battery, controls the electric quantity indicator to show the electric quantity signal and controls the battery to provide the operation power of the entity button.

Below, the embodiments are described in detail in cooperation with the drawings to make easily understood the technical contents, characteristics and accomplishments of the present invention.

### BRIEF DESCRIPTION OF THE DRAWINGS

FIG. 1 is a diagram schematically showing a multifunction back cover for cell phone according to an embodiment of the present invention;

FIG. 2 is a block diagram showing the internal circuit of a multifunction back cover for cell phone according to an embodiment of the present invention; and

FIG. 3 is a diagram schematically showing a multifunction back cover installed on a cell phone body according to an embodiment of the present invention.

### DETAILED DESCRIPTION OF THE INVENTION

Cell phones are more and more popular, especially smart phones. Many application programs have been developed, such as Apps. As a result, the power consumption of the application programs is very large. In order to operate the cell phone in an emergency situation when the power of the cell phone is used up, the present invention provides a multifunction back cover for cell phone, which cooperates with the application program of the cell phone body to provide operation functions added by a user, so as to improve application value.

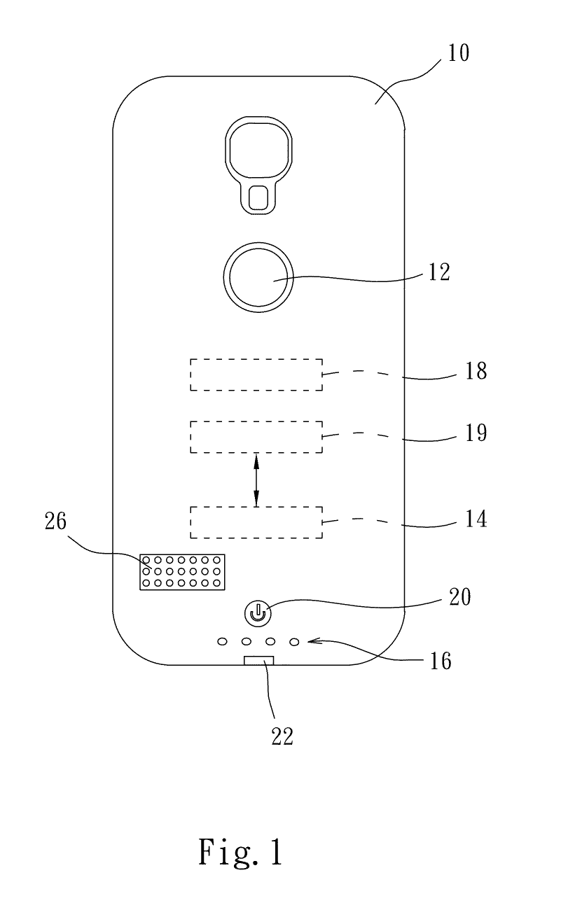

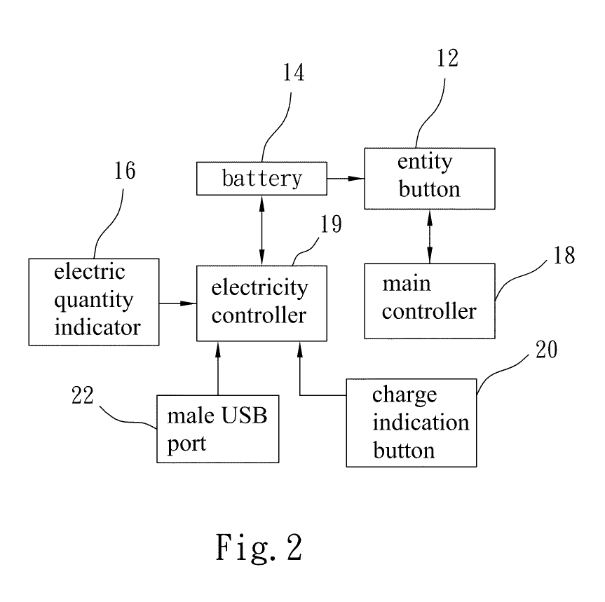

Refer to FIG. 1 and FIG. 2, which are diagrams respectively showing the structure and internal circuit of the present invention. The multifunction back cover for cell phone is installed on a cell phone body having at least one application mode. The back cover comprises a back cover body 10, an entity button 12, a battery 14, an electric quantity indicator 16, a main controller 18 and an electricity controller 19. The entity button 12 and the electric quantity indicator 16 are disposed on the back cover body 10. The battery 14, the main controller 18 and the electricity controller 19 are disposed in the back cover body 10. The main controller 18 is coupled to the entity button 12, and the electricity controller 19 is coupled to the battery 14 and the electric quantity indicator 16. The entity button 12 provides at least one function operation mode which is provided to a user for switching The main controller 18 cooperates with the function operation mode of the entity button 12 and the application mode of the cell phone body and sends out a control signal according to the function operation mode. For example, the function operation mode is a global positioning system (GPS) mode, a speed-dialing phone number mode, an emergency contact person mode, or an alarm mode, and the function operation mode is switched by the entity button 12 (as described below). When the cell phone has low electricity or no electricity, the battery 14 provides the operation power of the entity button 12 so that the entity button 12 uses enough electricity to operate the function operation mode. In order to ensure that the battery 14 has enough electricity, the electricity controller 19 monitors electric quantity of the battery 14 and controls the electric quantity indicator 16 to show an electric quantity signal. The electric quantity indicator 16 shows the electric quantity signal according to the electric quantity of the battery 14.

A charge indication button 20 and a male universal serial bus (USB) port 22 are disposed on the back cover body 10. The charge indication button 20 is coupled to the battery 14, the electricity controller 19, the electric quantity indicator 16 and the cell phone body. The electricity controller 19 controls the battery 14 to supply power to the cell phone body or shows the electric quantity signal by an operation signal of the charge indication button 20. The battery 14 is couple to the male USB port 22. When the male USB port 22 is coupled to a power device (not shown) through a charge line, the power device charges the battery 14 by the operation signal of the charge indication button 20. For example, the power device is realized with a power bank or utility power.

After introducing the structure of the present invention, the operation is described as below. The battery 14 of the present invention is a lithium battery whose capacity is 1000˜2800 mAh or a lithium battery pack with charge and discharge properties. The battery 14 has a working voltage of 3.7 V and features over voltage protection (OVP), over current protection (OCP) and short circuit protection (SCP). The battery 14 has a working temperature of 0˜45° C. when charging. The battery 14 has a working temperature of −20˜60° C. when discharging. The battery 14 has a temperature of −20˜35° C. when storing electricity. The battery 14 has the humidity of 45˜75% RH when storing electricity. The electric quantity of the battery 14 is known from the electric quantity indicator 16. The electricity controller endlessly monitors the electric quantity of the battery 14. In order to save power, the electric quantity indicator 16 cannot automatically show the electric quantity signal in normal times. In the embodiment, the electric quantity indicator 16 further comprises four light-emitting diodes (LEDs). The light of each LED shows that the electric quantity signal of the battery is 25%, and the light of one, two, three or four LEDs respectively shows that the electric quantity signal of the battery 14 is 25%, 50%, 75% or 100%. When the charge line is not coupled to the power device and the male USB port 22, the user can press down the charge indication button 20 so that the electricity controller 19 shows the electric quantity signal of the battery 14 by the operation signal triggered by the charge indication button 20. When the user wants to charge the battery 14, the user makes the charge line be coupled to the power device (not shown) and the male USB port 22 and presses down the charge indication button 20 so that the main controller 18 controls the power device to charge the battery 14 through the charge line. When the user presses down the charge indication button 20 again, the electric quantity signal is showed.

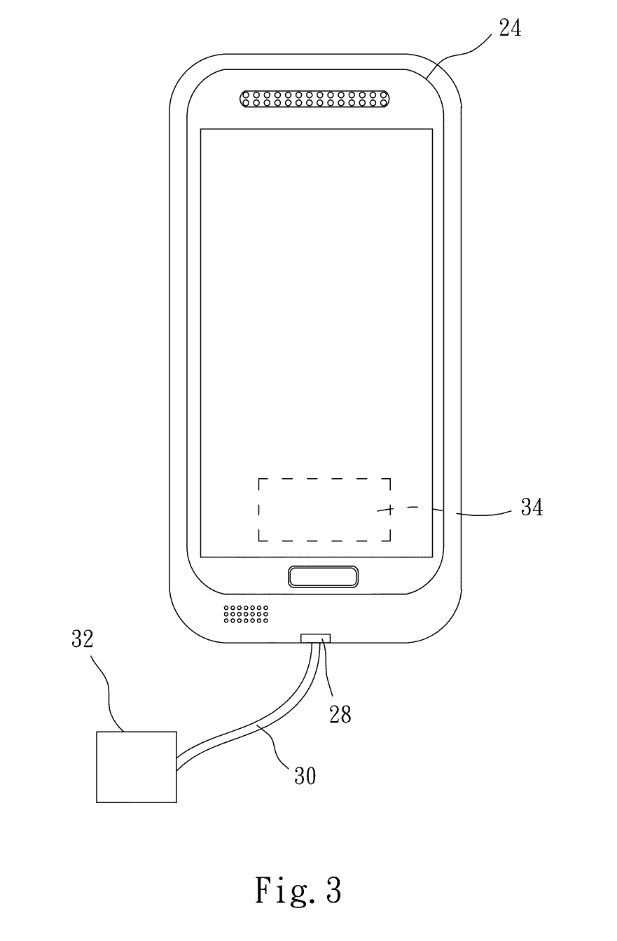

Refer to FIG. 1 and FIG. 3. FIG. 3 is a diagram schematically showing the multifunction back cover installed on the cell phone body. With technological advancements, many different Apps have been developed for cell phones. In order to cooperate with the functional element of the back cover body 10 and the cell phone body 24, the application mode of the cell phone body 24 is set to cooperate with the application functions of the back cover body 10. The application mode is realized with the App developed to cooperate with the back cover body 10. As a result, the main controller 18 of the back cover body 10 is coupled to the microprocessor of the cell phone body 24 to perform different function operation modes. For example, after the multifunction back cover is installed on the cell phone body 24, GPS mode, speed-dialing phone number mode, emergency contact person mode, message delivery mode and alarm mode are set in the application mode to be switched in cooperation with the entity button 12. Specifically, a phone number and the activity that the entity button 12 is short pressed for two seconds are set in the application mode of the cell phone body 24 used for speed-dialing phone number mode. When the user short presses down the entity button 12 for two seconds, the user can connect relatives and friends preset most intuitively and most rapidly. GPS function and the activity that the entity button 12 is endlessly pressed three times are set in the application mode of the cell phone body 24 used for GPS mode. When the user endlessly presses down the entity button 12 three times, the cell phone body 24 and the back cover body 10 are positioned to find their approximate positions or latitude and longitude positions. Since performing the GPS function consumes larger electric power, the battery 14 of the back cover body 10 provides electric power required by the GPS function. The main controller 18 sends out the control signal to the contact person preset according to the function operation mode. When the user climbs mountain, goes to the deserted area or gets lost, the user can start the GPS mode to find his own position. Alternatively, the GPS mode is provided to the police for rapidly searching the user. Message content, a phone number of a contact person and the activity that the entity button 12 is long pressed for five seconds are set in the application mode of the cell phone body 24 used for emergency contact person mode. When the user presses down the entity button 12 for five seconds, the message content preset is immediately delivered to the contact person by the phone number. Besides, user information and GPS position information are delivered in the emergency contact person mode. In addition to the message content preset, the GPS mode is started to deliver the position information of the user to the contact person. Thus, when the user gets lost in the mountains, is kidnapped by kidnappers, or meets an accident, the information of the user is immediately delivered to the contact person to advantage others to search or to find help.

The entity button 12 and the main controller 18 are coupled to a buzzer 26 disposed on the back cover body 10. When the function operation mode is alarm mode, the main controller 18 uses the buzzer 26 to send out the control signal. For example, sound mode, sound volume and the activity that the entity button 12 is long pressed for five seconds are set in the application mode of the cell phone body 24 used for alarm mode. When the user presses down the entity button 12 for five seconds, the main controller 18 uses the buzzer 26 to send out the control signal, such as the sound mode and the sound volume, to effectively deter kidnappers or catch the attention of the others. The abovementioned way of switching the function operation mode by the entity button 12 is not so limited. The setting of the application mode of the cell phone body 24 cooperating with the entity button 12 can be flexibly varied according to preference of the user.

In order to make the entity button 12 have enough electric power, the battery 14 of the back cover body 10 is independently charged. In addition, the male USB port 22 is couple to a female universal serial bus (USB) port 28 disposed on the cell phone body 24, and the position of the male USB port 22 corresponds to that of the female USB port 28. The power device 32 is coupled to the female USB port 28 through the charge line 30. The power device 32 charges the battery 14 and a main battery 34 of the cell phone body 24 by the operation signal of the charge indication button 20 when the charge indication button 20 is pressed down. When the female USB port 28 is not coupled to the charge line 30, the electricity controller 19 controls the battery 14 to supply power to the cell phone body 24 after pressing down the charge indication button 20.

In conclusion, the multifunction back cover for cell phone of the present invention not only provides additional electric power to the cell phone body but also switches the function operation mode by the unique entity button. The function operation modes, such as a directly-dialing phone number mode, a GPS mode and an alarm mode, are applied to seeking help and warning in an emergency situation to improve industrial application value and convenience of use for cell phones. Hence, the present invention has market competitiveness.

The embodiments described above are only to exemplify the present invention but not to limit the scope of the present invention. Therefore, any equivalent modification or variation according to the shapes, structures, features, or spirit disclosed by the present invention is to be also included within the scope of the present invention.

What is claimed is:

1. A multifunction back cover for cell phone, which is installed on a cell phone body, and said cell phone body has at least one application mode, said multifunction back cover comprising:
a back cover body;
an entity button disposed on said back cover body and providing at least one function operation mode;
a battery disposed in said back cover body, coupled to said entity button and providing operation power of said entity button;
an electric quantity indicator disposed on said back cover body and showing an electric quantity signal according to electric quantity of said battery;
a main controller disposed in said back cover body, coupled to said entity button, cooperating with said function operation mode of said entity button and said application mode of said cell phone body and sending out a control signal according to said function operation mode; and
an electricity controller coupled to said battery and said electric quantity indicator, monitoring said electric quantity of said battery, controlling said electric quantity indicator to show said electric quantity signal and controlling said battery to provide said operation power of said entity button.

2. The multifunction back cover for cell phone according to claim 1, wherein said function operation mode is a global positioning system (GPS) mode, a speed-dialing phone number mode, an emergency contact person mode, or an alarm mode, and said function operation mode is switched by said entity button.

3. The multifunction back cover for cell phone according to claim 2, wherein said entity button and said main controller are coupled to a buzzer disposed on said back cover body, and when said function operation mode is said alarm mode, said main controller uses said buzzer to send out said control signal.

4. The multifunction back cover for cell phone according to claim 2, wherein user information and GPS position information are delivered in said emergency contact person mode.

5. The multifunction back cover for cell phone according to claim 1, wherein said battery, said electricity controller, said electric quantity indicator and said cell phone body are coupled to a charge indication button disposed on said back cover body, and said electricity controller controls said battery to supply power to said cell phone body or shows said electric quantity signal by an operation signal of said charge indication button.

6. The multifunction back cover for cell phone according to claim 5, wherein said battery is couple to a male universal serial bus (USB) port disposed on said back cover body, and when said male USB port is coupled to a power device through a charge line, said power device charges said battery by said operation signal of said charge indication button.

7. The multifunction back cover for cell phone according to claim 6, wherein said male USB port is couple to a female universal serial bus (USB) port disposed on said cell phone body, and a position of said male USB port corresponds to that of said female USB port, and said power device is coupled to said female USB port through said charge line, and said power device charges said battery and a main battery of said cell phone body by said operation signal of said charge indication button.

8. The multifunction back cover for cell phone according to claim 1, wherein said battery is a lithium battery whose capacity is 1000˜2800 mAh.

9. The multifunction back cover for cell phone according to claim 1, wherein said electric quantity indicator further comprises four light-emitting diodes (LEDs), and light of each said LED shows that said electric quantity signal of said battery is 25%, and light of one, two, three or four said LEDs respectively shows that said electric quantity signal of said battery is 25%, 50%, 75% or 100%.
